(19) United States
(12) Patent Application Publication
(10) Pub. No.: US 2008/0243436 A1
(43) Pub. Date: Oct. 2, 2008

(54) INFORMATION PROCESSING APPARATUS, METHOD FOR MEASURING COOLING PERFORMANCE AND FOR DETECTING DETERIORATION IN THE PERFORMANCE

(75) Inventors: Tomonori Tsutsui, Hamura-shi (JP); Hideaki Andou, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/048,106

(22) Filed: Mar. 13, 2008

(30) Foreign Application Priority Data
Mar. 30, 2007 (JP) 2007-091660

(51) Int. Cl. G21C 17/00

(52) U.S. Cl. 702/182

(57) ABSTRACT

According to one embodiment, an information processing apparatus, includes a power consumption reading unit configured to read information corresponding to power consumption of a system, a temperature reading unit configured to read a temperature of the processor, a first storage unit configured to store power consumption P1 and a temperature T1, a load unit configured to impose a load on the processor, a second storage unit which stores power consumption P2 and a temperature T2 after the load is imposed, a calculation unit which calculates cooling performance ΔT from the power consumption P1 and the temperature T1 and the power consumption P2 and the temperature T2, and a reporting unit configured to report that the cooling performance of the system has deteriorated when the cooling performance value is higher than a setting value.

### CROSS-REFERENCE TO RELATED APPLICATIONS

This application is based upon and claims the benefit of priority from Japanese Patent Application No. 2007-091660, filed Mar. 30, 2007, the entire contents of which are incorporated herein by reference.

### BACKGROUND

1. Field

One embodiment of the invention relates to an information processing apparatus with a cooling system for cooling a processor. More specifically, the present invention relates to an information processing apparatus and a method for measuring cooling performance of a cooling system and for detecting deterioration in the cooling performance.

2. Description of the Related Art

The cooling performance of the processor lowers depending on a user use environment (e.g., use of a personal computer in a place with a lot of dust, or lifetime across the ages of a fan module) sometimes.

A technique, which determines that cooling performance of a cooling fan is lowered due to clogging of a dust-proof film in the case of a normal operation of the cooling fan and that the cooling fan is out of order in the case of an unordinary operation when the temperature of the processor to the outdoor air is higher than a prescribe temperature, has been disclosed in Jpn. Pat., Appln. KOKAI Publication No. 2006-127283.

Since the foregoing technique is one for a particular device with the dust-proof film which detects the deterioration in the cooling performance of the cooling fan caused by the clogging of the dust-proof film, the technique may not be applicable to a generic device without the dust-proof film.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating an appearance of an information processing apparatus regarding an embodiment of the invention;

FIG. 2 is an exemplary block diagram illustrating a system configuration of the information processing apparatus of FIG. 1;

FIG. 3 is an exemplary block diagram illustrating a system configuration for measuring a rotational frequency and cooling performance of a fan installed in the processing apparatus of FIG. 1;

FIG. 4 is an exemplary flowchart illustrating a procedure measuring the cooling performance using a cooling performance measuring tool and a procedure determining the cooling performance;

FIG. 5 is an exemplary flowchart illustrating a procedure measuring the cooling performance using a cooling performance measuring tool and a procedure determining the cooling performance;

FIG. 6 is an exemplary flowchart illustrating a procedure measuring the cooling performance using a cooling performance measuring tool and a procedure determining the cooling performance;

FIG. 7 is an exemplary flowchart illustrating a procedure measuring the cooling performance using a cooling performance measuring tool and a procedure determining the cooling performance;

FIG. 8 is an exemplary view illustrating an example of a window to be displayed on a liquid crystal display (LCD) by a notice display unit depicted in FIG. 3;

FIG. 9 is an exemplary view illustrating an example of a message by which an AC adapter depicted in FIG. 3 prompts a user to connect an AC adapter;

FIG. 10 is an exemplary view illustrating an example of a message by which a peak shift determining unit prompts the user to operate for disabling peak shift setting;

FIG. 11 is an exemplary view illustrating an example of a message by which the notice display unit depicted in FIG. 3 notifies the user to start measurement;

FIG. 12 is an exemplary view illustrating an example of a message by which the attention display unit depicted in FIG. 3 notifies the user that the processor is now in measurement;

FIG. 13 is an exemplary view illustrating an example of a message by which the notice display unit depicted in FIG. 3 notifies the user that the CPU is under a load;

FIG. 14 is an exemplary view for explaining cooling performance ΔT_{CPU};

FIG. 15 is an exemplary view illustrating an example to be displayed when it is determined that the termination result of the cooling performance is normal; and

FIG. 16 is an exemplary view illustrating an example of a message to be displayed when the termination result of the cooling performance is abnormal.

### DETAILED DESCRIPTION

Various embodiments according to the invention will be described hereinafter with reference to the accompanying drawings. In general, according to one embodiment of the invention, an information processing apparatus, comprises a system main unit, a processor disposed in the system main unit, a cooling system disposed in the system main unit and includes a cooling unit to cool the processor, a cooling control unit disposed in the system main unit and configured to control cooling performance of the cooling system, a power consumption reading unit disposed in the system main unit and configured to read information corresponding to power consumption of the system main unit, a temperature reading unit disposed in the system main unit and configured to read a temperature of the processor, a condition judgment unit disposed in the system main unit and configured to determine whether or not the system main unit satisfies a condition to detect a cooling performance value, a first storage unit configured to store information P′₁ corresponding to power consumption P₁ to be read by the power consumption reading unit and a temperature T₁ to be read by the temperature reading unit when it is determined that the system main unit satisfies the condition, a load unit configured to impose a load on the processor after the information P′₁ and the temperature T₁ are stored in the first storage unit, a second storage unit which stores information P′₂ corresponding to power consumption P₂ to be read by the power consumption reading unit and a temperature T₂ to be read by the temperature reading unit after the load is imposed, a calculation unit which calculates cooling performance ΔT from the power consumption P₁ and the temperature T₁ corresponding to the information P′₁ stored in the first storage unit and the power consumption P₂ and the temperature T₂ corresponding to the information P′₂ stored in the second storage unit, a cooling performance judgment unit configured to determine whether the calculated cooling performance ΔT is lower or not than a setting value, and a reporting unit configured to report that the cooling performance of the system main unit has deteriorated when the cooling performance value is higher than a setting value.

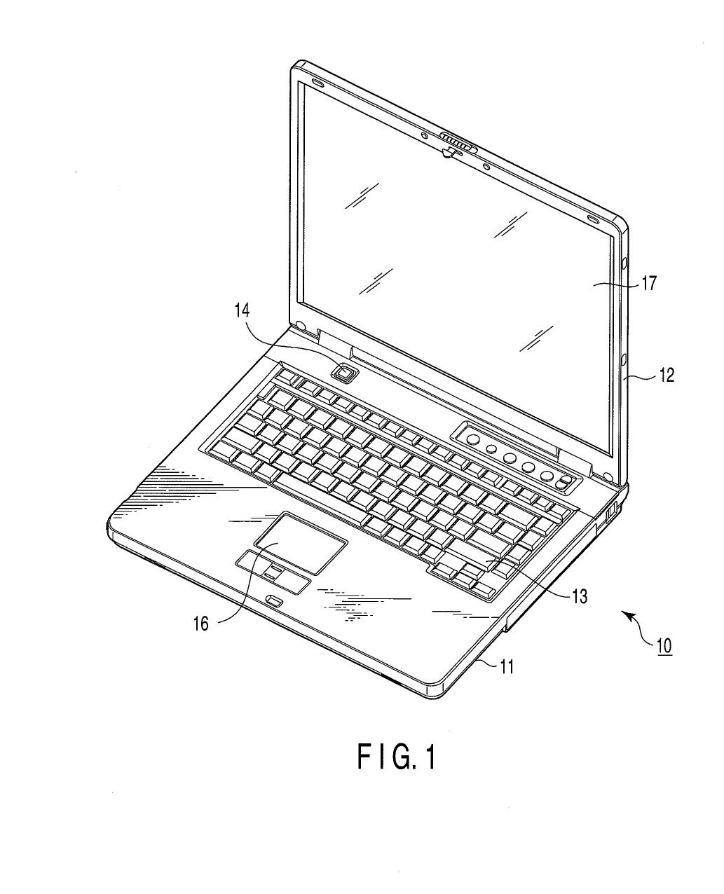

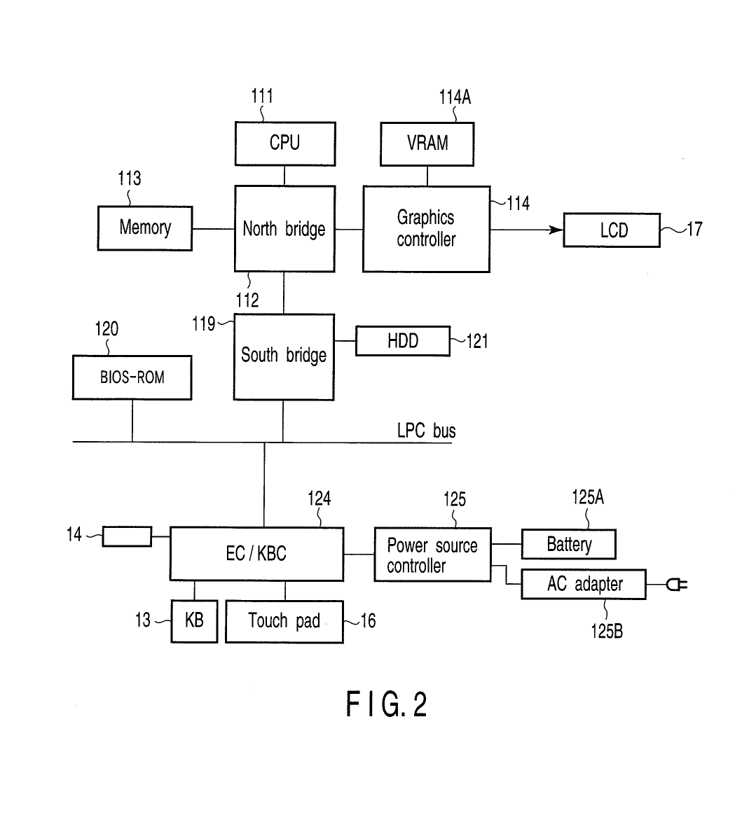

Referring now to FIGS. 1 and 2, a configuration of an information processing apparatus regarding an embodiment of the invention will be described. This information processing apparatus is realized as a portable notebook-type personal computer 10 which can be driven by a rechargeable battery.

FIG. 1 shows a perspective view in a state in which a display unit of the personal computer 10 is opened. The computer 10 is composed of a computer main unit 11, and a display unit 12. A display device composed of a liquid crystal display (LCD) 17 is installed in the display unit 12, and the display screen of the LCD 17 is positioned at almost the center of the display unit 12.

The display unit 12 is rotatably attached between an open position and a close position to the main unit 11. The main unit 11 has a housing which is shaped in a thin box, and a keyboard 13, a power button 14 for power on and off of the computer 10 and a touch panel 15, etc., are disposed on the upper surface of the housing.

Next, the system configuration of the computer 10 will be described with reference to FIG. 2.

The computer 10 includes, as shown in FIG. 2, a CPU 111, a north bridge 112, a main memory 113, a graphics controller 114, a south bridge 119, a basic input output system (BIOS)-ROM 120, a hard disk drive (HDD) 121, an optical disk drive (ODD) 122, an embedded controller and keyboard controller IC (EC/KBC) 124, and a power source controller (PWC) 125, etc.

The CPU 111 is a processor which is disposed for controlling an operation of the computer 10, and executes an operating system (OS) and a variety of application programs to be loaded on the main memory 113 from the HDD 121. The OS includes a window system for displaying a plurality of windows on the display screen.

The CPU 111 also executes the BIOS stored in the BIOS-ROM 120. The system BIOS is a program for controlling hardware.

The north bridge 112 is a bridge device which connects between a local bus and the south bridge 119. The north bridge 112 also has a memory controller to access and control the main memory 113 built-in. The north bridge 112 also has a function to execute communication with the graphics controller 114 via an accelerated graphics port (AGP) bus etc.

The graphics controller 114 is a display controller for controlling the LCD 17 to be used as the display monitor of the computer 10. The graphics controller 114 has a video memory (VRAM) and generates a video signal to form a display image to be displayed on the LCD 17 from the display data drawn on the VRAM by means of the OS and the application programs.

The south bridge 119 controls each device on a low pin count (LPC) bus. The south bridge 119 has an integrated drive electronics (IDE) controller for controlling the HDD 121 and the ODD 122 built-in. The south bridge 119 also has a function of controlling the access to the BIOS-ROM 120.

The EC/KBC 124 is a one-chip micro-computer with an embedded controller for controlling a power source and heat radiation and a keyboard controller for controlling the keyboard 13 and the touch pad 16 integrated thereon. This EC/KBC 124 has a function to turn on/turn off the computer depending on the operations of the power button by the user.

When an external power source is supplied through an AC adapter 125B, a power source controller (PWC) 125 generates power to be supplied to each component of the main computer 10 by using the external power source to be supplied from the AC adapter 125B. When the external power source is not supplied through the external power source, the PWC 125 generates system power to be supplied to each component of the computer 10.

Meanwhile, each guaranteed operating temperature is set to a semiconductor device, for example, the CPU 111, the north bridge 112, the south bridge 119, the graphics controller 114, etc. To operate the semiconductor device below the guaranteed operating temperature, a cooling fan is each attached to the semiconductor device. The cooling performance of the cooling fan lowers depending on a user use environment (e.g., use of personal computer in a place with a lot of dust, or lifetime across the ages of fan module) sometimes.

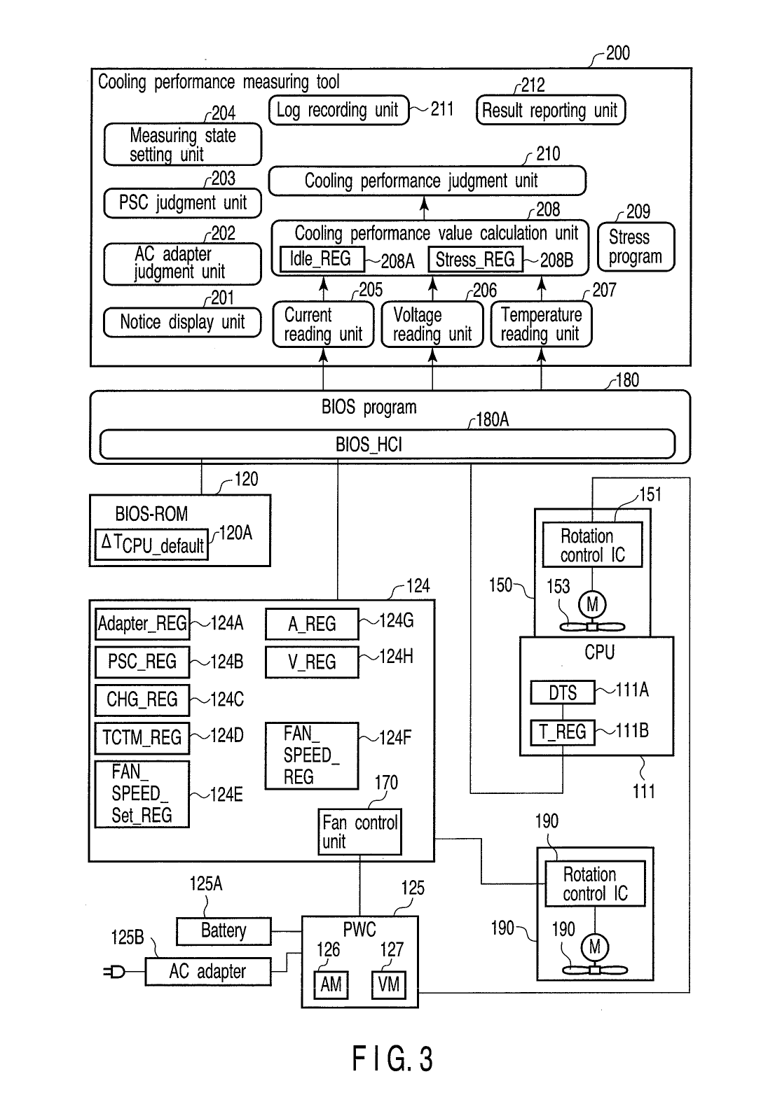

If the user uses a cooling performance measuring tool, the main computer 10 may visually recognize current cooling performance. Hereinafter, the tool for measuring the cooling system and the performance of the cooling mechanism will be described with reference to FIG. 3.

FIG. 3 shows a view depicting a configuration to control the rotation speed of the fan regarding the one embodiment of the invention.

A cooling fan 150 is attached to the CPU 111, as shown in FIG. 3. The computer 10 includes a cooling fan 190 for exhausting air within the computer main unit 11.

The cooling fan 150 includes a rotation control IC 151, a motor 152 and a fan 153. Applying a drive voltage applied from the PWC 125 to the motor M through the rotation control IC 151 rotates the fan 153. The rotation control IC monitors the rotation speed of the fan 153. The rotation control IC 151 supplies a pulse signal depending on the rotation speed of the fan 153 to the EC/KBC 124. The EC/KBC 124 stores the rotation speed depending on the supplied pulse signal in a rotation speed register (FAN_SPEED_REG) 124F.

The cooling fan 190 includes a rotation control IC 191, a motor 192 and a fan 193. Applying the drive voltage applied from PWC 125 to the motor M through the rotation control IC 191 rotates the fan 193. The rotation control IC 191 monitors the rotation speed of the fan 193. The control IC 191 supplies a pulse signal depending on the rotation speed of the fan 193 to the EC/KBC 124. The EC/KBC 124 stores the rotation speed depending on the supplied pulse signal in the FAN_SPEED_REG 124F.

The CPU 111 has a digital thermal sensor (DTS) 11A built-in. The DTS 111A monitors a temperature, the monitored temperature is stored in a temperature register 111B. When the monitored temperature exceeds a threshold set by the BIOS, the DTS 111A generates a temperature change interruption. The BIOS program detects the interruption to read the temperature register 111B.

Usually, a fan control unit 170 controls the drive voltage applied to the rotation control IC 151 of the cooling fan 150 from the PWC 125 so as to control the rotation speed of the fan 193 of the cooling fan 190. The BIOS-ROM 120 has stored the rotation speeds of the fans 153 and 193 depending on the temperatures.

By the way, in supplying the system power to each component of the computer 10, an ampere meter (AM) 126 measures a system current value and a voltmeter (VM) 127 measures a system voltage. The system current value and the system voltage value are supplied to the EC/KBC 124. The EC/KBC 124 stores the system current value in a current value register (A_REG) 124G and stores the system voltage in a voltage value register (V_REG) 124H.

Now, the EC/KBC 124 includes an AC adapter connection register (Adapter_REG) 124A, a peak shift setting register (PSC_REG) 124B, a charge setting register (CHG_REG) 124C, a thermal control TEST mode register (TCTM_REG) 124D, a rotation speed setting register (FAN_SPEED_Set_REG) 124E, etc., other than the aforementioned registers 124F, 124G and 124H.

A connection state of the AC adapter 125B is stored in the Adapter_REG 124A. The PSC_REG 124B has stored whether or not the peak shift control is enabled. The charge setting to a battery 125A is stored in the CHG_REG 124C. The TCTM_REG 124D has stored whether or not the thermal test mode is enabled. The setting for setting the rotation speed of the fan is stored in the FAN_SPEED_Set_REG 124E.

Hereinafter, the configuration to diagnose the cooling performance by the cooling performance tool will be described.

The measuring tool includes a notice display unit 201, an AC adapter judgment unit 202, a PSC judgment unit 203, a measuring state setting unit 204, a current reading unit 205, a voltage reading unit 206, a temperature reading unit 207, a cooling performance value calculation unit 208, a Stress program 209, a cooling performance judgment unit 210, a log recording unit 211, a result notification unit 212, etc.

The notice display unit 201 displays attention to measure the cooling performance. The adapter judgment unit 202 refers to the Adapter_REG 124A to determine whether or not the AC adapter 125B is connected. The PSC judgment unit 203 refers to the PSC_REG 124B to determine whether or not the peak shift control is enabled. The measuring state setting unit 204 sets a state necessary for measuring to the EC/KBC 124. The current reading unit 205 refers to the A_REG 124G to read the system current value. The voltage reading unit 206 refers to the V_REG 124H to read the system voltage value. The temperature reading unit 207 refers to the T_REG 111B through a BIOS_HCI 180A to read the temperature of the CPU 111. The calculation unit 208 calculates a cooling performance value from a value stored in an idle state register (Idle_REG) 208A and a value stored in a stress state register (Stress_REG) 208B. The Stress program 209 is a program to impose a load on the CPU 111. The judgment unit 210 compares the cooling performance value ΔT_{CPU} calculated by the calculation unit 208 with a reference value ΔT_{CPU}_{₁₃} _{default} stored in the BIOS-ROM 120 to determine whether the cooling performance is sufficient or not. The log recording unit 211 records the determination result from the judgment unit 210 in a log. The reporting unit 212 displays the determination result from the judgment unit 210 on the LCD 17.

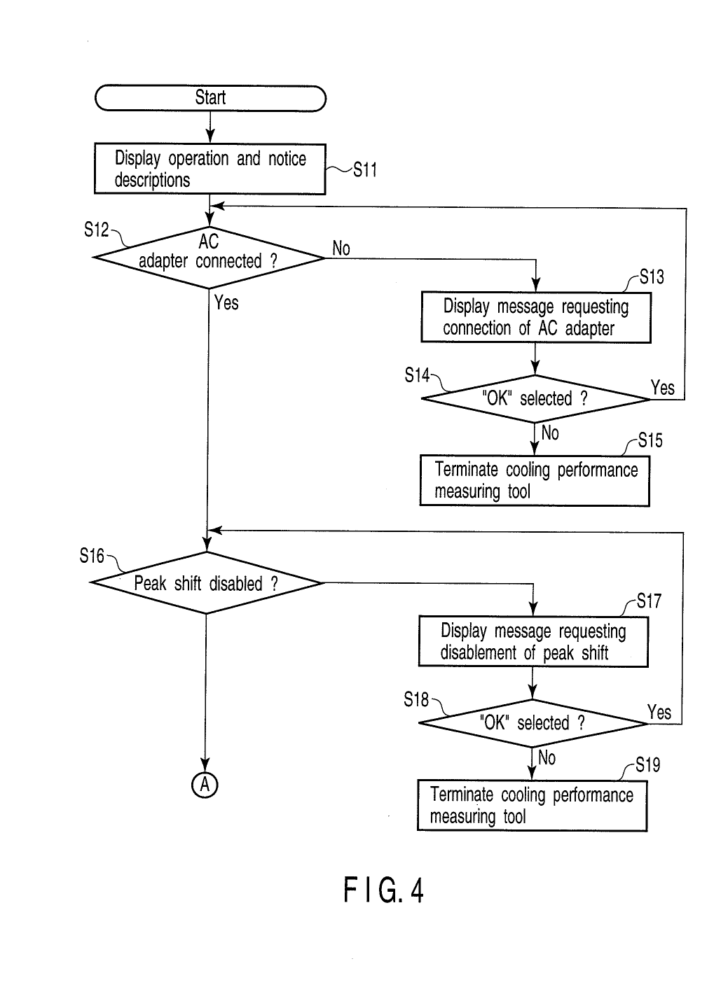

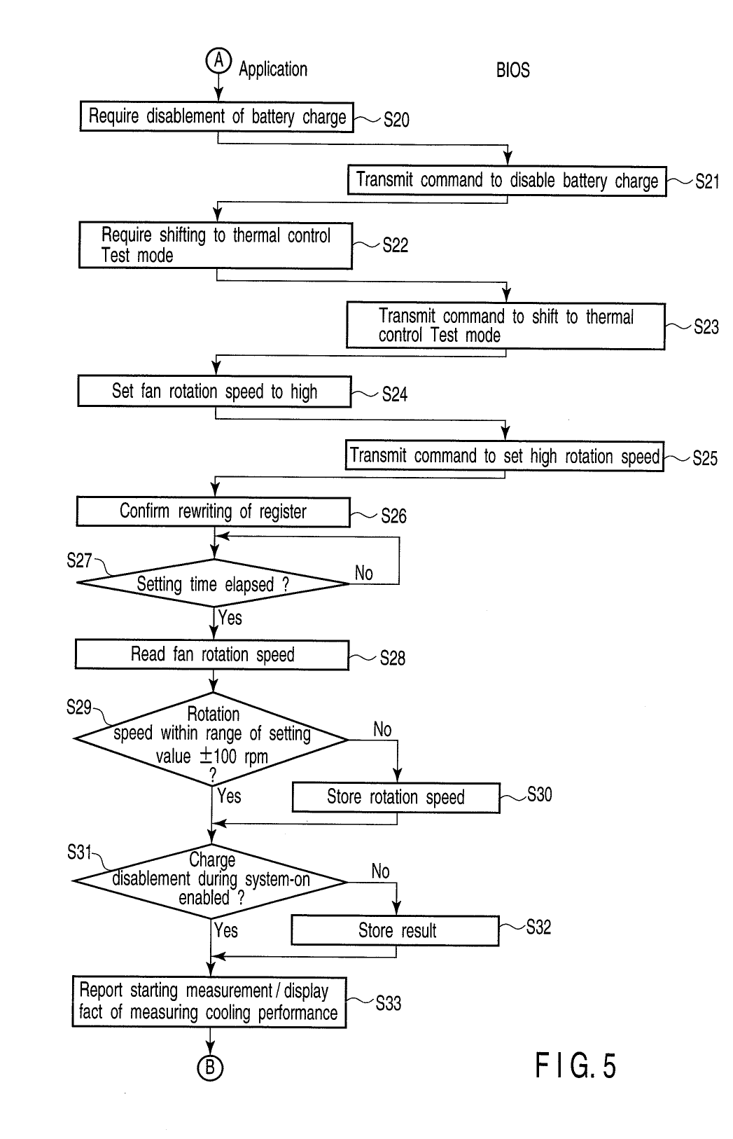

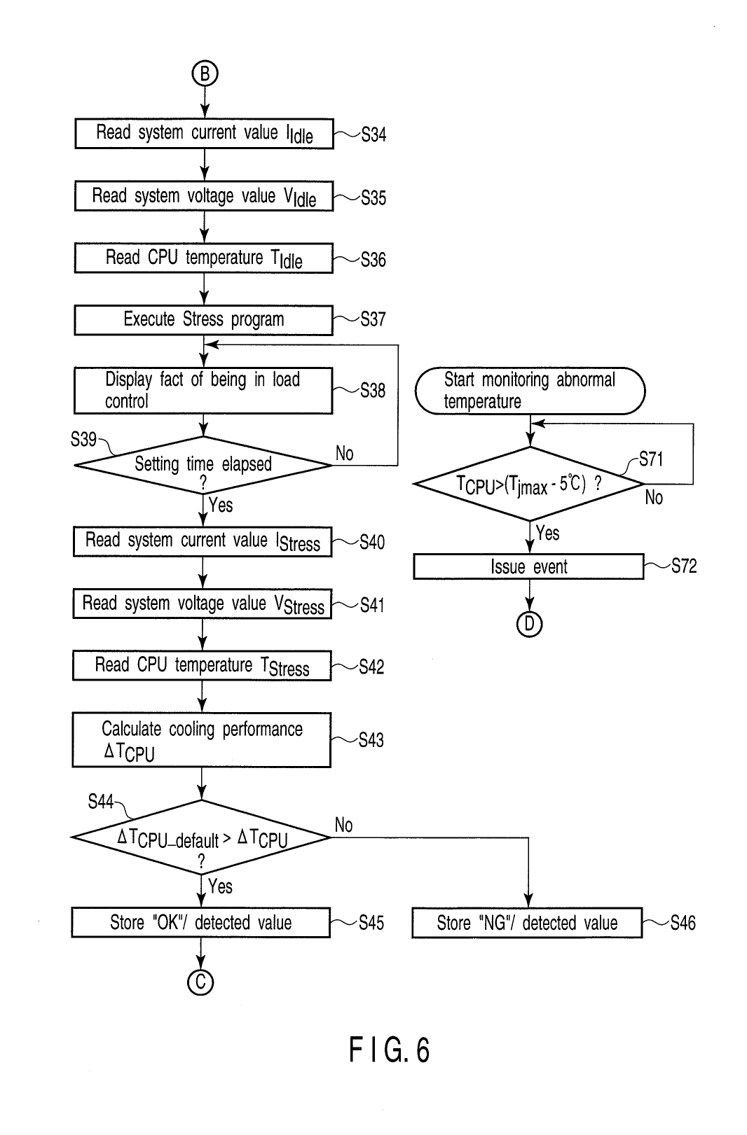

The following will describe the measurement and the determination of the cooling performance by the cooling performance measuring tool with reference to FIGS. 4-7. The FIGS. 4-7 show flowcharts each illustrating a procedure of the measurement and the determination of the cooling performance.

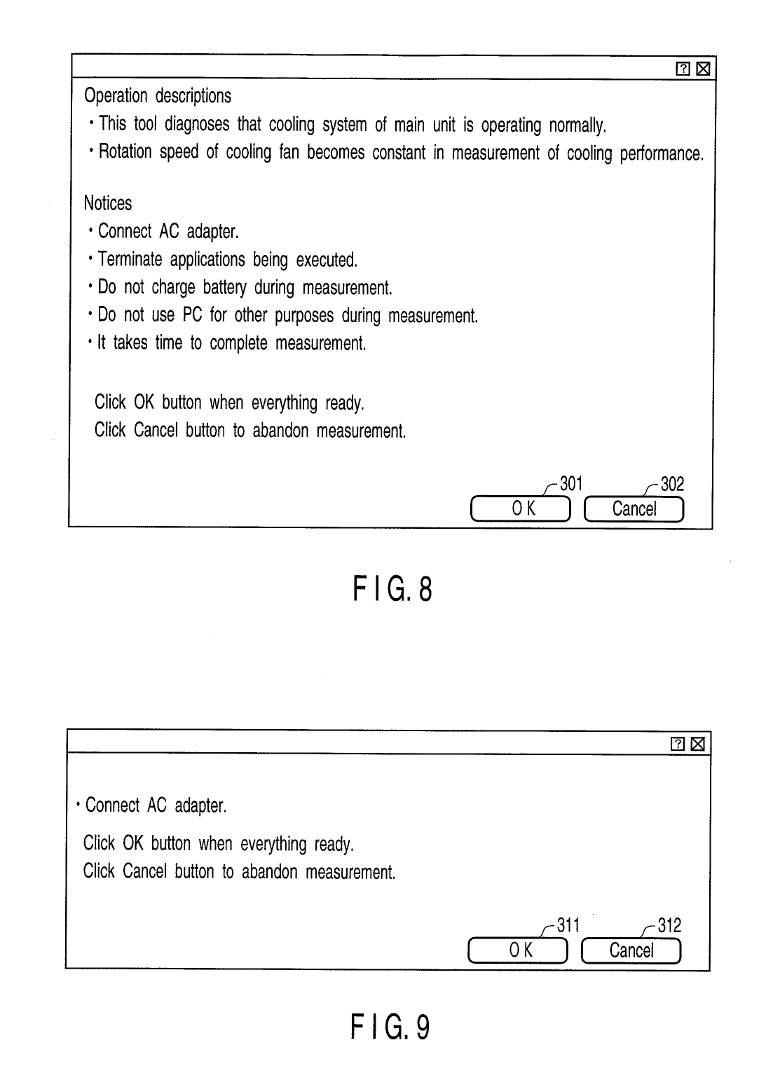

At first, when the user starts the cooling performance measuring tool, the notice display unit 201 displays operations and notices on the LCD 17 as shown in FIG. 8 (Step S11).

Operation descriptions are displayed as follows:

1) The measuring tool diagnostics that the cooling system of the computer operates normally

2) The rotation speed of the cooling fan becomes constant during measurement of the cooling performance.

The notices are displayed as follows:

1) Connect the AC adapter

2) Terminate the application being in use

3) Do not use the PC for other objects during measurement

4) It takes a time until the processing of the measuring tool terminates.

When an OK button 301 shown in FIG. 8 is clicked, the AC adapter judgment unit 202 reads the Adapter_REG 124A of the EC/KBC 124 through the BIOS_HCI 180A of the BIOS program 180. The judgment unit 202 determines whether or not the AC adapter 125B has already been connected to the computer (Step S12). When a Cancel button 302 is clicked, the Processing device stops the measurement.

In Step S12, if it is determined that the AC adapter 125B has not been connected (NO in Step S12) the judgment unit 202 displays a message of prompting the user to connect the AC adapter depicted in FIG. 9 on the LCD 17 (Step S13).

When the user operates any one of the OK button 311 and the Cancel button 312, is the judgment unit 202 determines whether or not the OK button 311 is clicked (Step S14). If it is determined that the OK button 311 is not clicked, the judgment unit 202 terminates the operation of the measuring tool 200 (Step S15). If it is determined that the OK button 311 is clicked, the judgment unit 202 returns to Step S12, the judgment unit 202 determines again whether or not the AC adapter 125B is connected to the computer 10.

In Step S12, if it is determined that the AC adapter is connected (YES in Step S12), the peak shift judgment unit 203 reads the PSC_REG 124B of the EC/KBC 144 via the BIOS_HCI 180A of the BIOS program 180. The judgment unit 203 determines whether or not the peak shift control is disabled (Step S16). The peak shift control is a function of arbitrarily setting a charge stop time period.

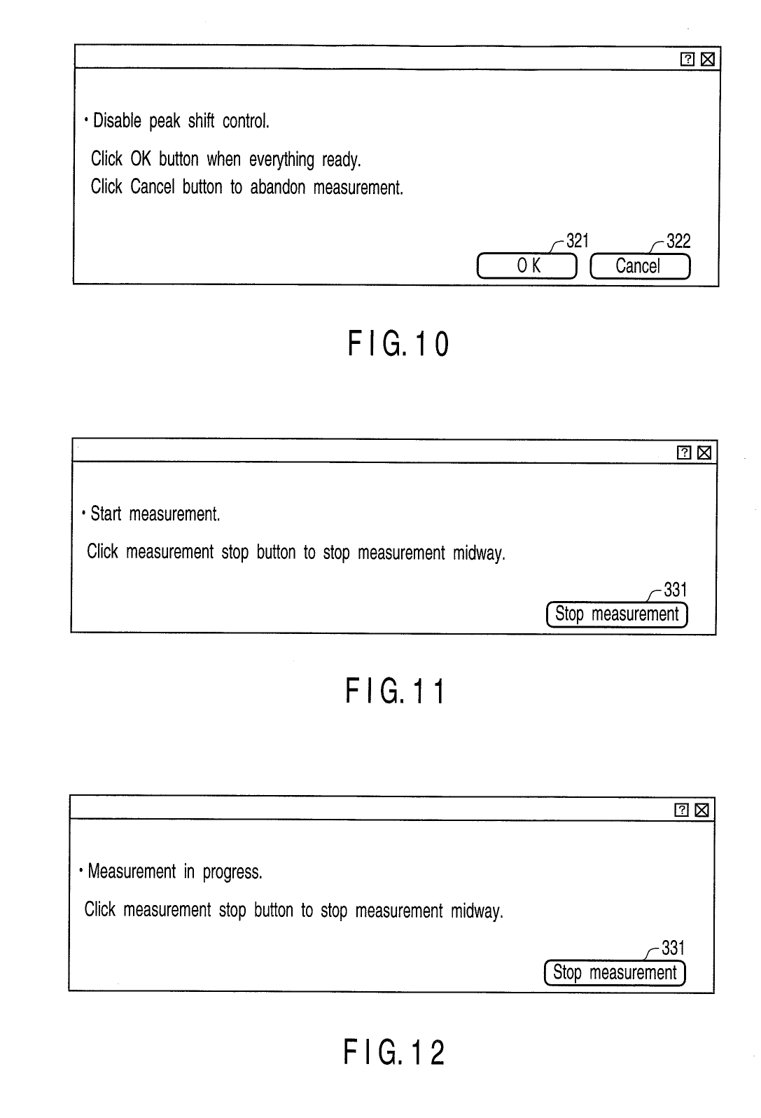

If the judgment unit 203 determines that the peak shift control is not disabled (NO in Step S16) the judgment unit 203 displays the message to prompt the user to operate for disabling the peak shift setting depicted in FIG. 10 on the LCD 17 (Step S17). When any one of the OK button 321 and the cancel button 322 is clicked, the judgment unit 203 determines whether the OK button 331 is clicked or not (Step S18). If it is determined that the OK button 321 is not clicked, the judgment unit 203 terminates the operation of the cooling performance measuring tool (Step S19). If it is determined that the OK button 321 is clicked, the peak shift judgment unit 203 returns to Step S16, and determines again whether the peak shift control is disabled or not.

If it is determined that the peak shift control is disabled in Step S16 (YES in Step S16), the measuring state setting unit 204 issues a battery charge disablement request to the BIOS program 180 (Step S20). The BIOS program 180 transmits a charge disablement during system-on command to the EC/KBC 124 (Step S20). The BIOS program 180 transmits a command of charge disablement during system-on to the EC/KBC 124 via the BIOS_HCI 180A (step S21). The EC/KBC 124 changes the value of the charge setting register (CHG_REG) 124C to enable the charge disablement during system-on. By reason of an occurrence of a charge current due to charging and an occurrence of measurement deviance of the cooling performance, the EC/KBC 124 prohibits the charging for the buttery 125A.

The measuring state setting unit 204 issues a thermal control TEST mode shift request to the BIOS program 180 (Step S22). The BIOS program 180 transmits the thermal control TEST mode sift command to the EC/KBC 124 through the BIOS_HCI 180A (Step S23). The EC/KBC 124 changes the value of the TCTM_REG 124D to enable the thermal control TEST mode. Usually, although the rotation speeds of the cooling fans 150 and 190 depending on the temperature of the CPU 111, the cooling fans 150 and 190 rotate by at the rotation speed stored in the FAN_SPEED_Set_REG 124E regardless of the temperature in the thermal control TEST mode.

The setting unit 204 issues a request for fixing the setting of the fan rotation speed to High to the BIOS program (step S24). The BIOS program 180 transmits the High rotation speed setting command to the EC/KBC 124 through the BIOS_HCI 180A (step S25). The EC/KBC 124 changes the value of the FAN_SPEED_Set_REG 124E to set the rotation speeds of the cooling fans 150 and 190 at High. For the reason of preventing variations in wind amount to make the cooling capacity constant, the EC/KBC 124 makes the rotation speeds of the cooling fans 150 and 190 constant.

After confirming the rewriting of the register (Step S26), the setting unit 204 waits for a setting time period (step S27).

After the lapse of the setting time period (YES in Step S27), the measuring state setting unit 204 reads the rotation speeds of the fans stored in the EC/KBC (Step S28). The setting unit 204 determines whether or not the rotation speeds are within a range of ±100 rpm to the setting value (step S29). If it is determined that the rotation speeds are not within the range (NO in Step S29), the setting unit 204 stores the rotation speeds in a register for storing detected values in the memory 113 in order to record the detected value in a log later (Step S30).

If it is determined that the rotation speeds are within the range in Step S29 (YES in Step S29), or after storing the rotation speeds in the register (Step S30), the setting unit 204 reads the charge disablement during system-on and determines whether or not the charge is inhibited during system-on (Step S31). If it is determined that a charge disablement during system-on mode is not set (NO in Step S31), the setting unit 204 registers that the charge disablement mode is not set in the register in the memory 113 (Step S32).

If it is determined that the charge disablement mode is set (YES in Step S31), or after registering the fact in the register (Step S32), the notice display unit 201 displays the window shown in FIG. 11 on the LCD 17 to notify the user to start measurement.

When measurement is started, the notice display unit 201 displays the window shown in FIG. 12 on the LCD 17 to notify the user the fact of being in measurement (Step S33). When measuring stop buttons 331 depicted in FIGS. 11 and 12 are pressed (Step S81), the flowchart shifts to Step S47.

The current reading unit 205 reads s current value I_{Idle} of the system from the I_REG 124G via the BIOS_HCI 180A to store the current value I_{Idle} in the idle state register 208A (Step S34). The current reading unit 205 reads the current values a plurality of times for every fixed time and sets an averaged value to the current value I_{Idle}.

The voltage reading unit 206 reads a voltage value V_{Idle} of the system from the V_REG 124H via the BIOS_HCI 180 A to store the voltage value V_{Idle} in the idle state register 208A (Step S35). The voltage reading unit 206 reads the voltage values a plurality of times for every fixed time to calculate an averaged value as the voltage value V_{Idle}.

The temperature reading unit 207 reads a temperature T_{Idle} of the CPU 111 from the T_REG 111B through the BIOS_HCI 180A to store the temperature T_{Idle} in the idle state register 208A (Step S36). The temperature reading unit 207 reads the temperatures a plurality of times for every fixed time to calculate an averaged value as the temperature T_{Idle}.

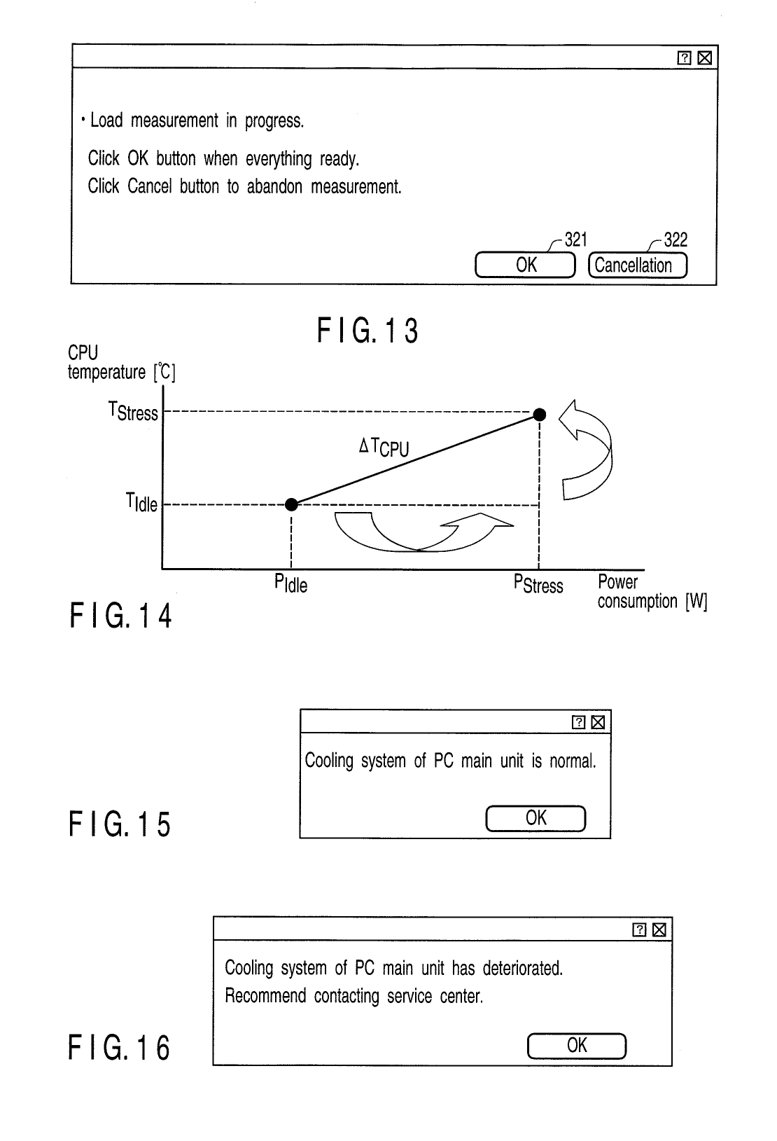

The cooling performance measuring tool 200 executes the Stress program 209 for imposing a load on the CPU 111 (Step S37). The notice display unit 201 displays the window depicted in FIG. 13 on the LCD 17 to notify the user the fact of imposing the load on the CPU 111.

During execution of the Stress program 209, the BIOS program 180 monitors the temperature of the CPU 111. If the temperature T_{CPU} of the CPU 111 becomes higher than a preset temperature (guaranteed operating temperature Tⱼₘₐₓ—5° C.) (YES in Step S71) the BIOS program 180 issues an event to the measuring tool (Step S72).

The measuring tool 200 waits for a fixed time (Step S39). Because of fixing the temperature of the CPU 111 in a state in which a load is imposed to the CPU 111 due to the execution of the Stress program, the measuring tool 200 waits for the fixed time.

After the lapse of the fixed time (YES in Step S39), the current reading unit 205 reads the current value I_{Stress} of the system from the I_REG 124G via the BIOS_HCI 180A to sore the current value I_{Stress} in the stress state register 208B (Step S40). The current reading unit 205 reads the current values a plurality of times for every fixed time to set an averaged value to the current value I_{Stress}.

The voltage reading unit 206 reads a voltage value V_{Stress} of the system from the V_REG 124H via the BIOS_HCI 180A to store the voltage value V_{Stress} in the stress state register 208B (Step S41). The voltage reading unit 206 reads the voltage values a plurality of times for every fixed time to set an averaged value as the voltage value V_{Stress}.

The temperature reading unit 207 reads a temperature T_{Stress} of the CPU 111 from the T_REG 111B through the BIOS_HCI 180A to store the temperature T_{Stress} in the stress state register 208B (Step S42). The temperature reading unit 207 reads the temperatures a plurality of time for every fixed time to set an averaged value to the temperature T_{Stress}.

The cooling performance value calculation unit 208 calculates cooling performance ΔT_{CPU} (Step S43).

The cooling performance value is obtained by the following expression:

ΔT_{CPU}=(T_{Stress}−T_{Idle})/(P_{Stress}−P_{Idle})

S_{Idle}=V_{Idle}×I_{Idle}

P_{Stress}=V_{Stress}×I_{Stress}

In other words, the ΔT_{CPU} is depicted as shown in FIG. 14.

The cooling performance judgment unit 210 reads a reference value ΔT_{CPU}_{_{—}}_{default} via the BIOS_HCI 180A and determines whether or not the reference value ΔT_{CPU}_{_{—}}_{default} is higher than the cooling performance ΔT_{CPU} (Step S44).

If it is determined that the reference value ΔT_{CPU}_{_{—}}_{default} is higher than the cooling performance T_{CPU} (YES in Step S44), the judgment unit 210 determines that the cooling performance is normal, and stores the determining result and the detected cooling performance ΔT_{CPU} in the register in the memory 113 (Step S45).

If it is determined that the reference value ΔT_{CPU}_{_{—}}_{default} is not higher than the cooling performance ΔT_{CPU} (NO in Step S44), the judgment unit 210 determines that the cooling performance is not sufficient, and stores the determining result and the detected cooling performance ΔT_{CPU} in the register in the memory 113 (Step S46).

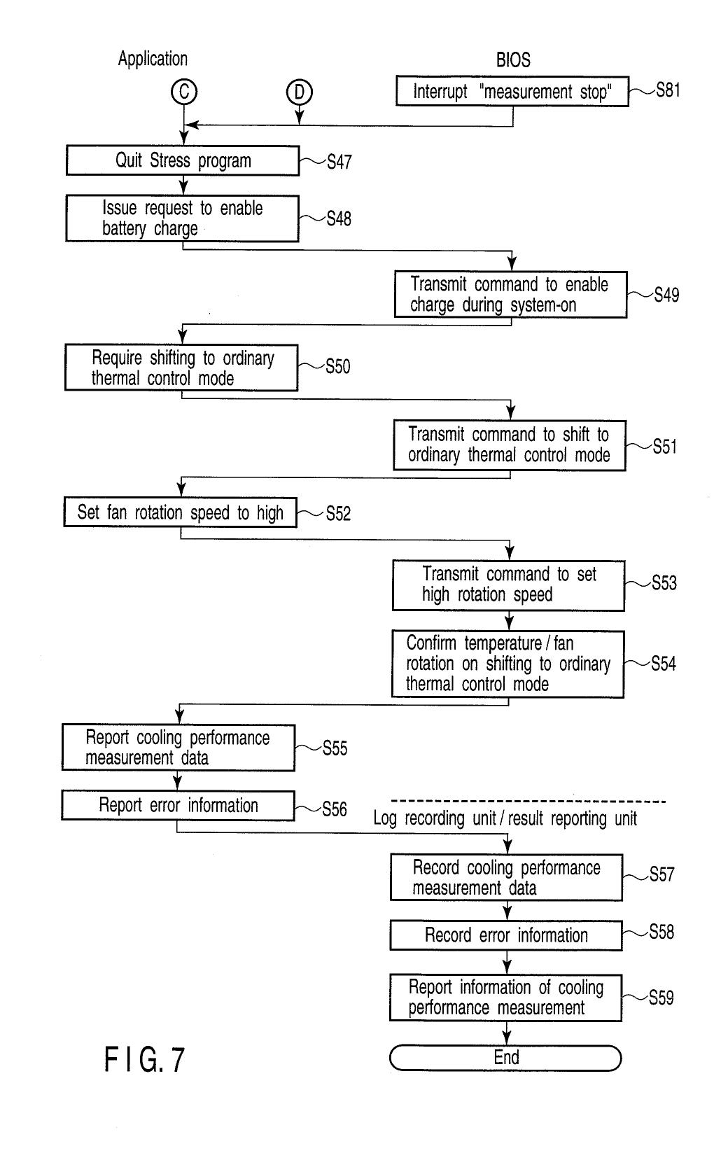

After the processing in Step S46, when the BIOS issues an event, (Step S71), or when the measurement stop buttons 331 shown in FIGS. 7 and 8 are pressed (Step S81), the measuring tool 200 stops the processing of the S_{Stress} program (Step S47).

The measuring state setting unit 204 issues the battery charge disablement request to the BIOS program 180 (Step S48). The BIOS program 180 transmits the charge disablement during system-on command to the EC/KBC 124 via the BIOS_HCI 180A (Step S49). The EC/KBC 124 rewrites the value of the CHG_REG 124C depending on the command.

The measuring unit 204 issues an ordinary thermal control mode shift request to the BIOS program 180 (Step S50). The BIOS program 180 transmits an ordinary thermal control mode shift command to the EC/KBC 124 via the BIOS_HCI 180A (Step S51). The EC/KBC 124 rewrites the TCTM_REG 124D in accordance with the command.

The BIOS program 180 confirms whether or not the system has shifted in the ordinary thermal mode (Step S52). To confirm the sift of the mode, the BIOS program 180 reads the temperature at the CPU and the rotation speeds of the cooling fans 150 and 190 and confirms whether or not the fans 150 and 190s have been rotating at the rotation speeds in accordance with the read temperature.

The measuring tool 200 reports the measurement data of the cooling performance to the log recording unit 211 (Step S55). The cooling performance measuring tool 200 reports a measuring date, a determination result of decision to pass or fail, power consumption, a temperature at the CPU. The measuring tool 200 reports error information to the recording unit 211 (Step S56).

The recording unit 211 records the notified measurement data of the cooling performance in the log on the HDD 121 (Step S57), and records the error information in the log on the HDD 121 (Step S58).

The result reporting unit 212 displays the determination result of the cooling performance on the LCD 17, as shown in FIG. 12 or 13 (Step S59). The window depicted in FIG. 15 shows the case in which it is determined that the cooling performance is normal, and the window depicted in FIG. 16 shows the case in which it is determined that the cooling performance is abnormal.

As mentioned above, the measuring tool 200 enables measuring the cooling performance. The present invention enables providing a service added value to the user by making a service complete so that the user may visually come to know the clogging with dust of fans and the aging of the fan modules.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a system main unit;
a processor disposed in the system main unit;
a cooling system disposed in the system main unit comprising a cooling unit to cool the processor;
a cooling control unit disposed in the system main unit and configured to control cooling performance of the cooling system;
a power consumption reading unit disposed in the system main unit and configured to read information corresponding to power consumption of the system main unit;
a temperature reading unit disposed in the system main unit and configured to read a temperature of the processor;
a condition judgment unit disposed in the system main unit and configured to determine whether or not the system main unit satisfies a condition to detect a cooling performance value;
a first storage unit configured to store information P′₁ corresponding to power consumption P₁ to be read by the power consumption reading unit and to store a temperature T₁ to be read by the temperature reading unit when it is determined that the system main unit satisfies the condition;
a load unit configured to impose a load on the processor after the information P′₁ and the temperature T₁ are stored in the first storage unit;
a second storage unit configured to store information P′₂ corresponding to power consumption P₂ to be read by the power consumption reading unit and to store a temperature T₂ to be read by the temperature reading unit after the load is imposed;
a calculation unit configured to calculate cooling performance ΔT from the power consumption P₁, temperature T₁, power consumption P₂, and temperature T₂;
a cooling performance judgment unit configured to determine whether or not the calculated cooling performance ΔT is lower than a setting value; and
a reporting unit configured to report that the cooling performance of the system main unit has deteriorated when the cooling performance value is higher than the setting value.

2. The information processing apparatus according to claim 1, wherein the cooling performance ΔT is expressed as follows:
ΔT=(T₂−T₁)/(P₂−P₁)

3. The information processing apparatus according to claim 1, further comprising:
a rechargeable battery built in the system main unit; and
a power source controller configured to generate system power to drive the system main unit from power supplied from the rechargeable battery or from external power, and to control charging of the rechargeable battery when the external power is supplied,
wherein the condition is that the external power has been supplied.

4. The information processing apparatus according to claim 3, wherein
the power source controller is configured to limit a time to charge the rechargeable buttery depending on a setting; and
the condition is that the setting to limit the time to charge the rechargeable battery has been disabled.

5. The information processing apparatus according to claim 3, further comprising a setting unit configured to set charge disablement to the rechargeable battery.

6. The information processing apparatus according to claim 3, wherein the power source controller comprises a current value measuring instrument configured to measure an electrical current value of the system power, and a voltage value measuring instrument configured to measure a voltage value of the system power,
wherein the power consumption reading unit is configured to read the electrical current value measured by the current value measurement instrument and the voltage value measured by the voltage value measuring instrument.

7. The information processing apparatus according to claim 1, further comprising a termination reporting unit configured to notify a user to terminate an unnecessary application before determining whether or not the system main unit satisfies the condition to detect a cooling performance value.

8. The information processing apparatus according to claim 1, further comprising a load stop unit configured to stop imposing the load on the processor when the temperature of the processor is higher than a setting value while the load is imposed on the processor.

9. A method for measuring cooling performance and for detecting deterioration in the cooling performance of an information processing apparatus provided with a cooling system which is disposed in the system main unit and comprises a processor and a cooling unit to cool the processor, comprising:
determining whether or not the system main unit satisfies a condition to detect a cooling performance value;
reading information P′₁ corresponding to power consumption P₁ of the system main unit when it is determined that the system main unit satisfies the condition;
reading a temperature T₁ of the processor when it is determined that the system main unit satisfies the condition;
imposing a load on the processor after reading the information P′₁ and the temperature T₁;
reading information P′₂ corresponding to power consumption P₂ of the system main unit after imposing the load;
reading a temperature T₂ after imposing the load;
calculating cooling performance ΔT from the power consumption P₁, the temperature T₁, the power consumption P₂ and the temperature T₂;
determining whether or not the calculated cooling performance ΔT is lower than a setting value; and
reporting that cooling performance of the system main unit has deteriorated when the cooling performance value is higher than a setting value.

10. The method according to claim 9, wherein the cooling performance ΔT is expressed as follows:
ΔT=(T₂−T₁)/(P₂−P₁).

11. The method according to claim 9, wherein the information processing apparatus further comprises:
a rechargeable battery which is built in the system main unit; and
a power source controller configured to generate system power to drive the system main unit from power supplied from the rechargeable battery or from external power, and to control charging of the rechargeable battery when the external power is supplied,
wherein the condition is that the external power has been supplied.

12. The method according to claim 11, wherein the power source controller is configured to limit a time to charge the rechargeable buttery depending on a setting; and
the condition is that the setting to limit the time to charge the rechargeable battery has been disabled.

13. The method according to claim 11, further comprising disabling charging of the rechargeable battery before reading the information P′₁ corresponding to the power consumption P1 of the system main unit.

14. The method according to claim 11, wherein the power source controller comprises a current value measuring instrument configured to measure an electrical current value of the system power; and a voltage value measuring instrument configured to measure a voltage value of the system power, and wherein reading the information P′₁ and P′₂ comprises reading a measured electrical current value by from the current value measuring instrument and a measured voltage value from the voltage value measuring instrument.

15. The method according to claim 9, further comprising notifying a user to terminate an unnecessary application before determining the condition.

16. The method according to claim 9, further comprising removing the load from the processor when the temperature of the processor is higher than a setting value while the load is imposed on the processor.
